(19) United States
(12) Patent Application Publication
(10) Pub. No.: US 2023/0254778 A1
(43) Pub. Date: Aug. 10, 2023

(54) METHOD FOR MITIGATING RECEIVER SENSITIVITY DEGRADATION

(71) Applicant: Apple Inc., Cupertino, CA (US)

(72) Inventors: Anatoliy S Ioffe, Sunnyvale, CA (US); Fucheng Wang, Cupertino, CA (US); Daniel Popp, Munich (DE)

(21) Appl. No.: 17/862,123

(22) Filed: Jul. 11, 2022

Related U.S. Application Data
(60) Provisional application No. 63/306,879, filed on Feb. 4, 2022.

(51) Int. Cl. H04W 52/24; H04W 52/36; H04L 5/14

(52) U.S. Cl. CPC H04W 52/243; H04W 52/241; H04W 52/365; H04L 5/14

(57) ABSTRACT

A communication system may include user equipment (UE) communicatively coupled to one or more base stations. The UE and/or the one or more base stations may receive an indication of self-interference at the UE. This indication may be based on a receiver of the UE (e.g., a receive signal quality, a receive signal power, and so on), a transmitter of the UE (e.g., a transmission power), an estimate of self-interference, and so on. If there is sufficient self-interference (e.g., if the self-interference exceeds a threshold), then the one or more base stations may configure the UE for non-simultaneous receive/transmit operation to avoid transmission interfering with reception. If there is a lack of self-interference (e.g., if the self-interference does not exceed the threshold), then the one or more base stations may configure the UE for simultaneous receive/transmit operation, as transmission is unlikely to interfere with reception.

### CROSS-REFERENCE TO RELATED APPLICATIONS

This application claims priority to U.S. Provisional Application No. 63/306,879, filed Feb. 4, 2022, entitled “METHOD FOR MITIGATING RECEIVER SENSITIVITY DEGRADATION,” the disclosure of which is incorporated by reference in its entirety for all purposes.

### BACKGROUND

The present disclosure relates generally to wireless communication, and more specifically to interference of received signals at a wireless communication device as caused by transmission by the wireless communication device.

Cellular networks deployed according to the 4th generation (4G) or long term evolution (LTE®) specifications and beyond (e.g. 5th generation (5G) or New Radio (NR), etc.) employ carrier aggregation as a technique to increase total aggregate bandwidth available for a communication link between a base station (BS) and user equipment (UE). Carrier aggregation may include receiving (RX) wireless signals on a first component carrier and transmitting (TX) wireless signals on a second component carrier. If reception and transmission does not occur at the same time or concurrently, then this may be referred to as non-simultaneous receive-transmit (RX/TX) operation. On the other hand, if reception and transmission does occur at the same time or concurrently, then this may be referred to as simultaneous RX/TX operation.

Because transmitting signals over certain frequencies can cause harmonic or intermodulation interference with receiving signals over other frequencies, certain specifications (e.g., the 4G or 5G specifications) may not enable UEs to perform simultaneous RX/TX operation over certain frequency combinations for carrier aggregation or dual connectivity (e.g., enabling a UE to aggregate data streams using two different specifications, such as LTE® and NR). However, in some circumstances, such as when transmission power is low or receive signal strength is high, harmonic or intermodulation interference may not occur or have little to no impact on a receive signal.

Additionally, for certain TX/RX frequency combinations, certain specifications mandate that UEs to perform simultaneous RX/TX operation as demanded by the service providers. However, in some circumstances, such as when transmission power is high or receive signal quality is low, harmonic or intermodulation interference may occur to those combinations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment includes a receiver, a transmitter, and processing circuitry communicatively coupled to the receiver and the transmitter. The processing circuitry determines a level of interference to the receiver caused by the transmitter, causes the transmitter to send first user data and the receiver to receive second user data concurrently based on the level of interference not exceeding a threshold, and cause the transmitter to send the first user data and the receiver to receive the second user data at non-overlapping times based on the level of interference not exceeding the threshold.

In another embodiment, one or more tangible, non-transitory, machine-readable media, stores machine-readable instructions that cause processing circuitry to transmit an indication that user equipment is capable of switching between a simultaneous receive-transmit operation and a non-simultaneous receive-transmit operation, and send an indication of receiver sensitivity degradation to a base station. The machine-readable instructions also cause the processing circuitry to receive a configuration to perform the simultaneous receive-transmit operation or the non-simultaneous receive-transmit operation based on the indication of receiver sensitivity degradation, and perform the simultaneous receive-transmit operation or the non-simultaneous receive-transmit operation.

In yet another embodiment, a method, includes determining self-interference of a transmitter and a receiver of user equipment, and determining whether the self-interference exceeds a threshold. The method also includes configuring the user equipment for non-simultaneous receive-transmit operation based on the self-interference exceeding the threshold, and configuring the user equipment for simultaneous receive-transmit operation based on the self-interference not exceeding the threshold.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment (UE), according to embodiments of the present disclosure;

FIG. 2 is a functional diagram of the UE of FIG. 1, according to embodiments of the present disclosure;

FIG. 3 is a schematic diagram of a transmitter of the UE of FIG. 1, according to embodiments of the present disclosure;

FIG. 4 is a schematic diagram of a receiver of the UE of FIG. 1, according to y embodiments of the present disclosure;

FIG. 5 is a schematic diagram of a cellular network including the user equipment of FIG. 1, according to embodiments of the present disclosure;

FIG. 6 is a timing diagram of non-simultaneous RX/TX operation using two frequency division duplexing (FDD) bands, according to embodiments of the present disclosure;

FIG. 7 is a timing diagram of non-simultaneous RX/TX operation using an FDD band and a time division duplexing (TDD) band, according to embodiments of the present disclosure;

FIG. 8 is a timing diagram of non-simultaneous RX/TX operation using two TDD bands, according to embodiments of the present disclosure;

FIG. 9 is a timing diagram of simultaneous RX/TX operation using two FDD bands, according to embodiments of the present disclosure;

FIG. 10 is a timing diagram of simultaneous RX/TX operation using an FDD band and a TDD band, according to embodiments of the present disclosure;

FIG. 11 is a timing diagram of simultaneous RX/TX operation using two TDD bands, according to embodiments of the present disclosure;

FIG. 12 is a communication system where there is low path loss between the UE of FIG. 1 and a first base station and low path loss between the UE and a second base station, according to embodiments of the present disclosure;

FIG. 13 is a communication system where there is low path loss between the UE and the first base station and high path loss between the UE and the second base station, according to embodiments of the present disclosure;

FIG. 14 is a communication system where there is high path loss between the UE and the first base station and low path loss between the UE and the second base station, according to embodiments of the present disclosure;

FIG. 15 is a communication system where there is high path loss between the UE and the first base station and high path loss between the UE and the second base station, according to embodiments of the present disclosure;

FIG. 16 is a flowchart of a method for self-interference mitigation at the UE by causing the UE to operate in a non-simultaneous RX/TX mode or a simultaneous RX/TX mode, according to embodiments of the present disclosure;

FIG. 17 is a flowchart of a method for self-interference mitigation at the UE by dynamically causing the UE to operate in a non-simultaneous RX/TX mode or a simultaneous RX/TX mode, according to embodiments of the present disclosure; and

FIG. 18 is a flowchart of a method for self-interference mitigation at the UE by causing the UE to operate in a non-simultaneous RX/TX mode or a simultaneous RX/TX mode as driven by a base station, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure is directed to interference of received signals at a wireless communication device as caused by transmission by the wireless communication device. Carrier aggregation, as implemented by the 4th generation (4G) or long term evolution (LTE®) specifications and beyond (e.g. 5th generation (5G) or New Radio (NR), etc.), may include receiving (RX) wireless signals on a first component carrier and transmitting (TX) wireless signals on a second component carrier. In particular, the RX wireless signals may include data (e.g., user data) received from a base station, and the TX wireless signals may include data (e.g., user data) sent to a base station. If reception and transmission does not occur at the same time or concurrently, then this may be referred to as non-simultaneous RX/TX operation. On the other hand, if reception and transmission does occur at the same time or concurrently, then this may be referred to as simultaneous RX/TX operation.

Certain specifications (e.g., the 4G or 5G specifications) may not enable user equipment (e.g., UE) to perform simultaneous RX/TX operation over certain frequency combinations for carrier aggregation or dual connectivity (e.g., enabling a UE to aggregate data streams using two different specifications, such as LTE® and NR) because transmitting signals over certain frequencies can cause harmonic or intermodulation interference (which may generally be referred to as self-interference or receiver sensitivity degradation) with receiving signals over other frequencies. However, in some circumstances, such as when transmission power is low or receive signal strength is high, such self-interference may not occur or have little to no impact on a receive signal. Additionally, for certain TX/RX frequency combinations, certain specifications mandate a UE to perform simultaneous RX/TX operation as demanded by the service providers. However, in some circumstances, such as when transmission power is high or receive signal quality is low, such self-interference may occur to those combinations.

Embodiments disclosed herein provide various apparatuses and techniques to mitigate interference to received signals at a wireless communication device as caused by transmission by the wireless communication device. In particular, a communication system may include a UE communicatively coupled to one or more base stations. The UE and/or the one or more base stations may receive an indication of self-interference or receiver sensitivity degradation at the UE. This indication may be based on a receiver of the UE (e.g., a receive signal quality, a receive signal power, and so on), a transmitter of the UE (e.g., a transmission power), an estimate of self-interference, and so on. If there is sufficient self-interference (e.g., if the self-interference exceeds a threshold), then the one or more base stations may configure the UE for non-simultaneous RX/TX operation to avoid transmission interfering with reception. If there is a lack of self-interference (e.g., if the self-interference does not exceed the threshold), then the one or more base stations may configure the UE for simultaneous RX/TX operation, as transmission is unlikely to interfere with reception.

In some cases, determining when the UE should operate in a non-simultaneous RX/TX mode or a simultaneous RX/TX mode may be dynamic. For example, the UE may periodically or occasionally send the indication of self-interference to the one or more base stations, such as when requesting to uplink data. The one or more base stations may then configure the UE for non-simultaneous or simultaneous RX/TX operation based on the indication. In additional or alternative cases, determining when the UE should operate in a non-simultaneous RX/TX mode or a simultaneous RX/TX mode may be event-driven. For example, if the UE is on an edge of (e.g., leaving or entering) a coverage area of the one or more base stations, the one or more base stations may receive or determine self-interference at the UE, and then configure the UE for non-simultaneous or simultaneous RX/TX operation based on the self-interference at the UE.

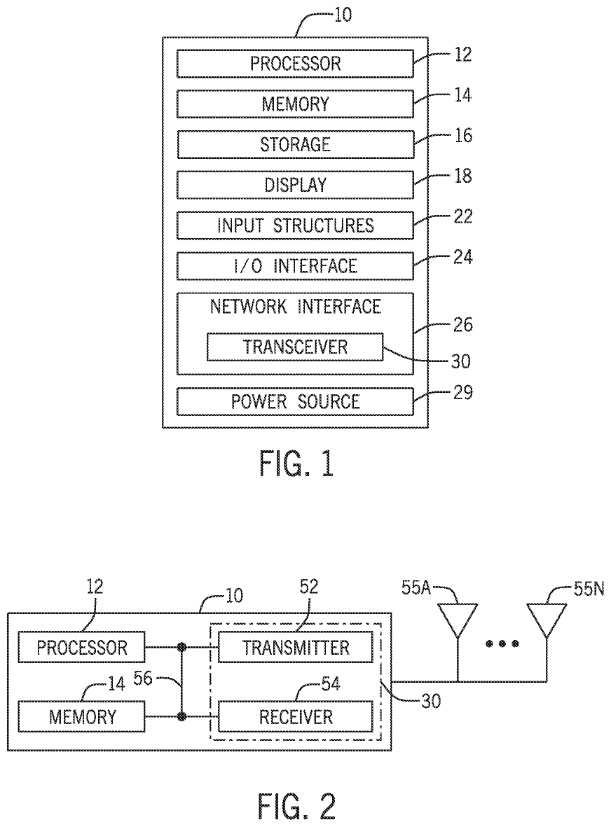

With this in mind, FIG. 1 is a block diagram of user equipment (UE) 10 (e.g., an electronic device), according to embodiments of the present disclosure. The UE 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the UE 10.

By way of example, the UE 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, Calif.), a portable electronic or handheld electronic device such as a wireless electronic device or smartphone (e.g., in the form of a model of an iPhone® available from Apple Inc. of Cupertino, Calif.), a tablet (e.g., in the form of a model of an iPad® available from Apple Inc. of Cupertino, Calif.), a wearable electronic device (e.g., in the form of an Apple Watch® by Apple Inc. of Cupertino, Calif.), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the UE 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the UE 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the UE 10 to provide various functionalities.

In certain embodiments, the display 18 may facilitate users to view images generated on the UE 10. In some embodiments, the display 18 may include a touch screen, which may facilitate user interaction with a user interface of the UE 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the UE 10 may enable a user to interact with the UE 10 (e.g., pressing a button to increase or decrease a volume level). The I/O interface 24 may enable UE 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, Calif., a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a satellite network, a non-terrestrial network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the UE 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the UE 10 may include any suitable source of power, such as a rechargeable lithium polymer (Li-poly) battery and/or an alternating current (AC) power converter.

FIG. 2 is a functional diagram of the UE 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The UE 10 may include the transmitter 52 and/or the receiver 54 that respectively enable transmission and reception of data between the UE 10 and an external device via, for example, a network (e.g., including base stations) or a direct connection. As illustrated, the transmitter 52 and the receiver 54 may be combined into the transceiver 30. The UE 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled a respective transceiver 30 and each emit radio frequency signals that may constructively and/or destructively combine to form a beam. The UE 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the UE 10 may be coupled together by a bus system 56. The bus system 56 may include a data bus, for example, as well as a power bus, a control signal bus, and a status signal bus, in addition to the data bus. The components of the UE 10 may be coupled together or accept or provide inputs to each other using some other mechanism.

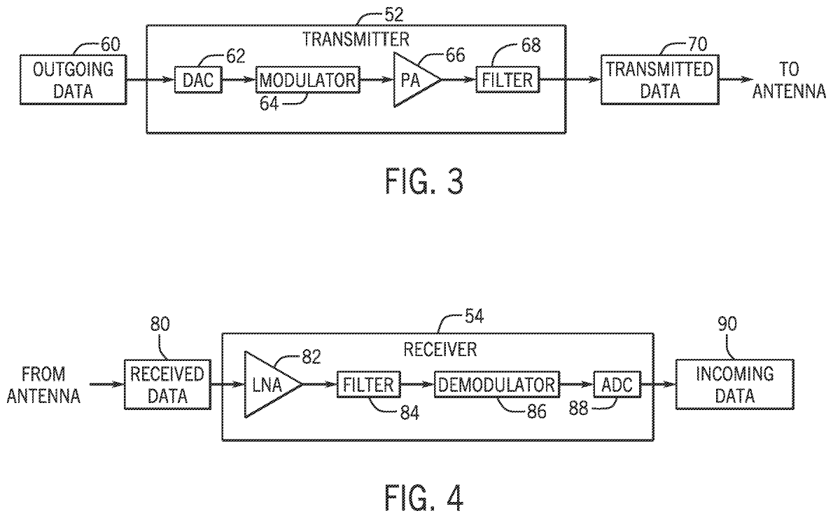

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted data 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received data 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. A demodulator 86 may remove a radio frequency envelope and/or extract a demodulated signal from the filtered signal for processing. An analog-to-digital converter (ADC) 88 may receive the demodulated analog signal and convert the signal to a digital signal of incoming data 90 to be further processed by the UE 10. Additionally, the receiver 54 may include any suitable additional components not shown, or may not include certain of the illustrated components, such that the receiver 54 may receive the received data 80 via the one or more antennas 55. For example, the receiver 54 may include a mixer and/or a digital down converter.

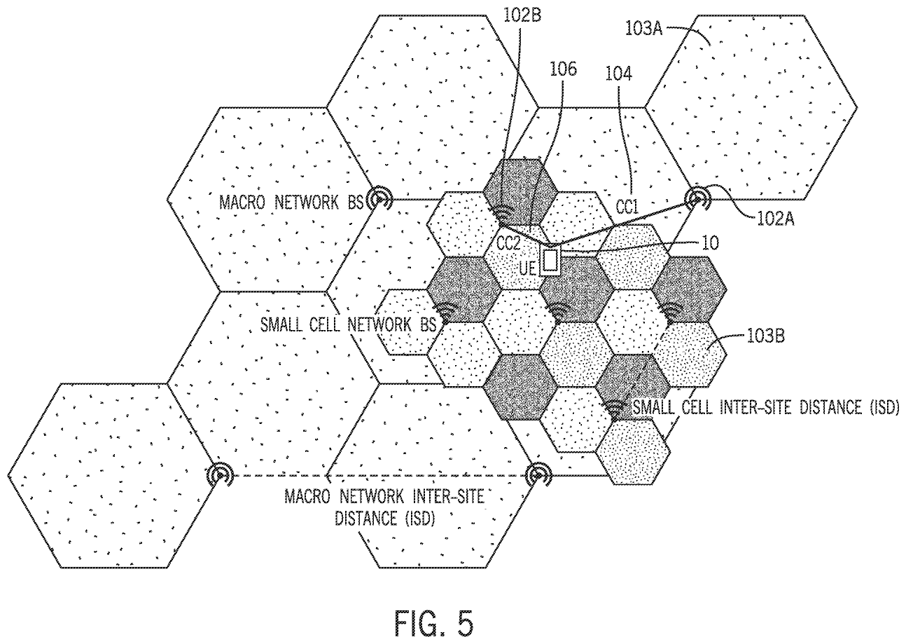

FIG. 5 is a schematic diagram of a cellular network 100 including the user equipment 10 of FIG. 1, according to embodiments of the present disclosure. As illustrated, the network 100 may include base stations 102A, 102B (collectively 102), such as macro network base stations 102A and small cell network base stations 102B. Each macro network base station 102A provides macro network coverage to coverage areas 103A for which the macro base station 102A is centered. Similarly, each small cell network base station 102B provides small cell network coverage to coverage areas 103B for which the small cell base station 102B is centered. The base stations 102 may include Evolved NodeB (eNodeB) base stations that provide 4G/LTE® coverage, Next Generation NodeB (gNodeB or gNB) base stations that provide 5G/NR coverage, or any other suitable communication hubs or nodes that provide network coverage. In a carrier aggregation configuration between bands of different frequencies, networks employing low frequency bands (e.g., low-band 5G of 600-900 megahertz (MHz) or less, mid-band 5G of 2.3-4.7 gigahertz (GHz) or less) may be termed as a macro network (as provided by the macro network base stations 102A), and networks employing high frequency bands (e.g., mmWave frequencies, such as 24-300 GHz or more) may be termed as a small cell network (as provided by the small cell network base stations 102B).

As illustrated, the cellular network 100 includes both a macro network and a small cell network, and the UE 10 is communicatively coupled to a macro network base station 102A of the macro network via a first component carrier (CC1) 104 and a small cell network base station 102B of the small cell network via a second component carrier (CC2) 106. It should be understood that while two component carriers are used throughout the disclosure as examples, more component carriers are contemplated. Cellular network operators depend on spectrum licenses to obtain regulatory approval to operate networks in certain frequencies. Thus, a given operator may own multiple license in different frequencies. The 4G and 5G specifications define base station 102 and UE 10 requirements for carrier aggregation operation, and, generally, any combination of deployed carriers may be specified in the corresponding specification.

A typical parameter in link budgeting of cellular network layouts is a loss of signal strength between a base station 102 and the UE 10, which is termed path loss. By varying density of deployed base stations 102 in a given area, average path loss may be controlled in the overall network 100. By scaling density of the deployed base stations 102, the network 100 may scale overall deployment for the carrier aggregation operation, such that average target path loss for each frequency corresponds to design targets. The network 100 of FIG. 5 represents such a cellular network layout. It should be understood that the base stations 102 may include at least some of the components of the user equipment 10 shown in FIGS. 1 and 2, including one or more processors 12, the memory 14, the storage 16, the transmitter 52, and the receiver 54. It should be understood that the network 100 may include any suitable number of base stations 102 (e.g., one or more base stations 102, four or more base stations 102, ten or more base stations 102, and so on).

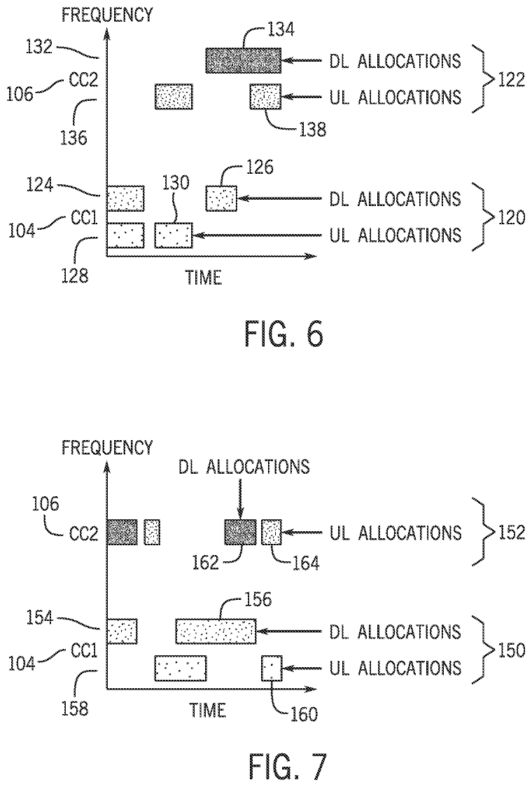

Carrier aggregation, as implemented by the 4G or LTE® specifications and beyond (e.g. 5G or NR, etc.), may include receiving (RX) wireless signals on a first component carrier (e.g., 104) and transmitting (TX) wireless signals on a second component carrier (e.g., 106). If reception and transmission does not occur at the same time or concurrently, then this may be referred to as non-simultaneous RX/TX operation. With non-simultaneous RX/TX operation, as shown in FIGS. 6-8, restrictions on uplink and/or downlink allocations per component carrier (CC) may be introduced by a network scheduler (e.g., of a network implemented using base stations) to ensure that the UE 10 does not simultaneously transmit on the first component carrier 104 while receiving on a second component carrier 106.

FIG. 6 is a timing diagram of non-simultaneous RX/TX operation using two frequency division duplexing (FDD) bands 120, 122, according to embodiments of the present disclosure. As illustrated, the first component carrier (CC1) 104 is scheduled by the network 100 to enable the UE 10 to receive on a first frequency range (e.g., a downlink (DL) frequency range) 124 of a first FDD band 120 during downlink allocations 126, and transmit on a second frequency range (e.g., an uplink (UL) frequency range) 128 of the first FDD band 120 during uplink allocations 130. That is, the DL frequency range 124 is solely used for reception, and the UL frequency range 128 is solely used for transmission. Additionally, the second component carrier (CC2) 106 is scheduled by the network 100 to enable the UE 10 to receive on a first frequency range (e.g., a DL frequency range) 132 of a second 1-DD band 122 during downlink allocations 134, and transmit on a second frequency range (e.g., a UL frequency range) 136 of the second FDD band 122 during uplink allocations 138. That is, the DL frequency range 132 is solely used for reception, and the UL frequency range 136 is solely used for transmission. The timing diagram of FIG. 6 illustrates non-simultaneous RX/TX operation using two FDD bands 120, 122, as receiving operations do not overlap in time (e.g., occur simultaneously or concurrently) with transmitting operations.

FIG. 7 is a timing diagram of non-simultaneous RX/TX operation using an 1-DD band 150 and a time division duplexing (TDD) band 152, according to embodiments of the present disclosure. As illustrated, the first component carrier (CC1) 104 is scheduled by the network 100 to enable the UE 10 to receive on a first frequency range (e.g., a DL frequency range) 154 of the 1-DD band 150 during downlink allocations 156, and transmit on a second frequency range (e.g., a UL frequency range) 158 of the first 1-DD band 150 during uplink allocations 160. That is, the DL frequency range 154 is solely used for reception, and the UL frequency range 158 is solely used for transmission. Additionally, the second component carrier (CC2) 106 is scheduled by the network 100 to enable the UE 10 to receive on the TDD band 152 during downlink allocations 162, and transmit on the TDD band 152 during uplink allocations 164. That is, the same frequency range (e.g., the TDD band 152) is used for reception and transmission, but reception occurs at different times than transmission. The timing diagram of FIG. 7 illustrates non-simultaneous RX/TX operation using the FDD band 150 and the TDD band 152, as receiving operations do not overlap in time (e.g., occur simultaneously or concurrently) with transmitting operations.

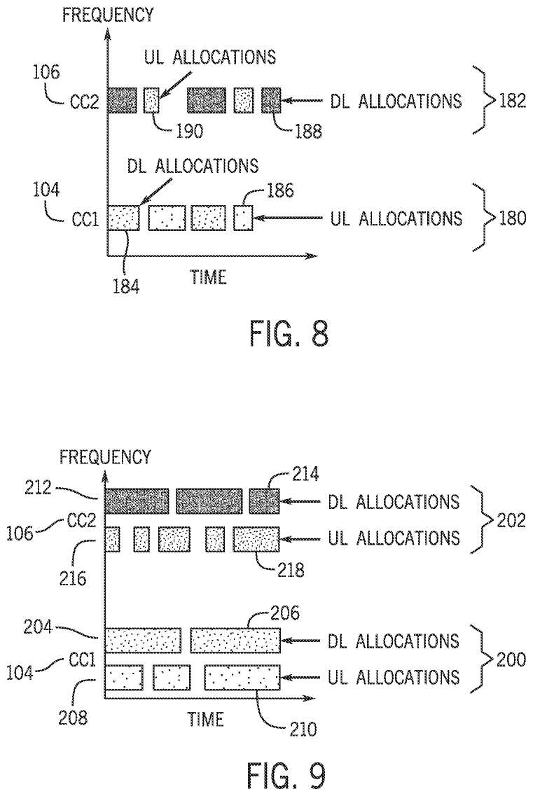

FIG. 8 is a timing diagram of non-simultaneous RX/TX operation using two TDD bands 180, 182, according to embodiments of the present disclosure. As illustrated, the first component carrier (CC1) 104 is scheduled by the network 100 to enable the UE 10 to receive on a first TDD band 180 during downlink allocations 184, and transmit on the first TDD band 180 during uplink allocations 186. That is, the same frequency range (e.g., the first TDD band 180) is used for reception and transmission, but reception occurs at different times than transmission. Additionally, the second component carrier (CC2) 106 is scheduled by the network 100 to enable the UE 10 to receive on a second TDD band 182 during downlink allocations 188, and transmit on the second TDD band 182 during uplink allocations 190. That is, the same frequency range (e.g., the second TDD band 182) is used for reception and transmission, but reception occurs at different times than transmission. The timing diagram of FIG. 8 illustrates non-simultaneous RX/TX operation using the TDD bands 180, 182, as receiving operations do not overlap in time (e.g., occur simultaneously or concurrently) with transmitting operations.

Scheduling non-simultaneous RX/TX operation to ensure that receiving operations do not overlap in time (e.g., occur simultaneously or concurrently) with transmitting operations may use processing and/or networking resources. Moreover, the task may gain further complexity when considering different propagation delay between the base stations 102 and the UE 10, which the network 100 may take into account when scheduling the UE for non-simultaneous RX/TX operation. As such, scheduling simultaneous RX/TX operation, where reception and transmission may occur at the same time or concurrently, may be simpler and conserve processing and/or networking resources. Moreover, since receiving and transmitting may occur concurrently or simultaneously, simultaneous RX/TX operation, as shown in FIGS. 9-11, may achieve much better data throughput than non-simultaneous RX/TX operation.

FIG. 9 is a timing diagram of simultaneous RX/TX operation using two FDD bands 200, 202, according to embodiments of the present disclosure. As illustrated, the first component carrier (CC1) 104 is scheduled by the network 100 to enable the UE 10 to receive on a first frequency range (e.g., a DL frequency range) 204 of the first FDD band 200 during downlink allocations 206, and transmit on a second frequency range (e.g., a UL frequency range) 208 of the first FDD band 200 during uplink allocations 210. That is, the DL frequency range 204 is solely used for reception, and the UL frequency range 208 is solely used for transmission. Additionally, the second component carrier (CC2) 106 is scheduled by the network 100 to enable the UE 10 to receive on a first frequency range (e.g., a DL frequency range) 212 of the second FDD band 202 during downlink allocations 214, and transmit on a second frequency range (e.g., a UL frequency range) 216 of the second 1-DD band 202 during uplink allocations 218. That is, the DL frequency range 212 is solely used for reception, and the UL frequency range 216 is solely used for transmission. The timing diagram of FIG. 9 illustrates simultaneous RX/TX operation using the two FDD bands 200, 202, as receiving operations overlap in time (e.g., occur simultaneously or concurrently) with transmitting operations.

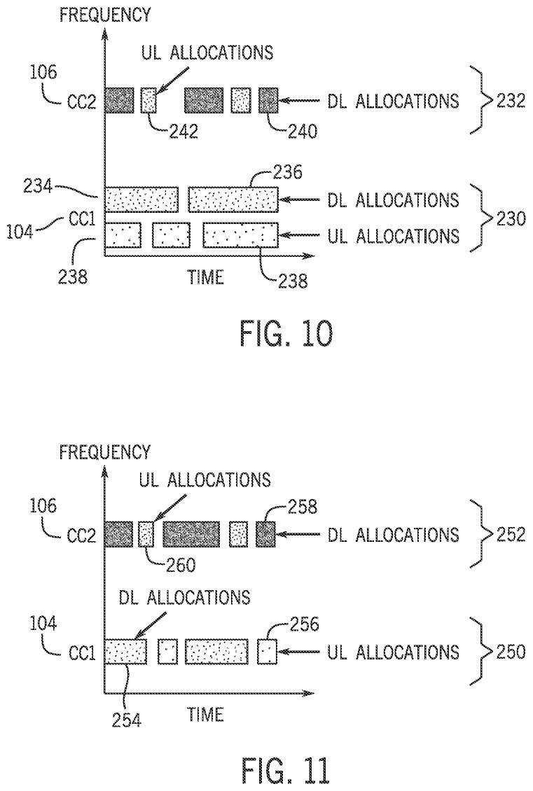

FIG. 10 is a timing diagram of simultaneous RX/TX operation using an FDD band 230 and a TDD band 232, according to embodiments of the present disclosure. As illustrated, the first component carrier (CC1) 104 is scheduled by the network 100 to enable the UE 10 to receive on a first frequency range (e.g., a DL frequency range) 234 of the 1-DD band 230 during downlink allocations 236, and transmit on a second frequency range (e.g., a UL frequency range) 238 of the FDD band 230 during uplink allocations 240. That is, the DL frequency range 234 is solely used for reception, and the UL frequency range 238 is solely used for transmission. Additionally, the second component carrier (CC2) 106 is scheduled by the network 100 to enable the UE 10 to receive on the TDD band 232 during downlink allocations 240, and transmit on the TDD band 232 during uplink allocations 242. That is, the same frequency range (e.g., the TDD band 232) is used for reception and transmission, but reception occurs at different times than transmission. The timing diagram of FIG. 10 illustrates simultaneous RX/TX operation using the FDD band 230 and the TDD band 232, as receiving operations overlap in time (e.g., occur simultaneously or concurrently) with transmitting operations.

FIG. 11 is a timing diagram of simultaneous RX/TX operation using two TDD bands 250, 252, according to embodiments of the present disclosure. As illustrated, the first component carrier (CC1) 104 is scheduled by the network 100 to enable the UE 10 to receive on a first TDD band 250 during downlink allocations 254, and transmit on the first TDD band 250 during uplink allocations 256. That is, the same frequency range (e.g., the first TDD band 250) is used for reception and transmission, but reception occurs at different times than transmission. Additionally, the second component carrier (CC2) 106 is scheduled by the network 100 to enable the UE 10 to receive on a second TDD band 252 during downlink allocations 258, and transmit on the second TDD band 252 during uplink allocations 260. That is, the same frequency range (e.g., the second TDD band 252) is used for reception and transmission, but reception occurs at different times than transmission. The timing diagram of FIG. 11 illustrates simultaneous RX/TX operation using the two TDD bands 250. 252, as receiving operations overlap in time (e.g., occur simultaneously or concurrently) with transmitting operations.

Certain specifications (e.g., the 4G or 5G specifications) may not enable the UE 10 to perform simultaneous RX/TX operation over certain frequency combinations for carrier aggregation or dual connectivity (e.g., enabling the UE 10 to aggregate data streams using two different specifications, such as LTE® and NR) because transmitting signals over certain frequencies can cause harmonic or intermodulation interference (which may generally be referred to as self-interference) with receiving signals over other frequencies. That is, transmitting signals over the certain frequencies may result in uplink aggressor harmonic or intermodulation interference with a downlink victim component carrier, causing maximum sensitivity degradation (MSD) at the receiver 54 of the UE 10, which may negatively impact reference sensitivity (REFSENS) of the receiver 54. The 3GPP provides the UE 10 with the capability of signaling to the network that it is capable of performing simultaneous RX/TX operation (e.g., in TDD-TDD and/or TDD-FDD inter-band NR carrier aggregation) via a simultaneous RX/TX InterBandCA field.

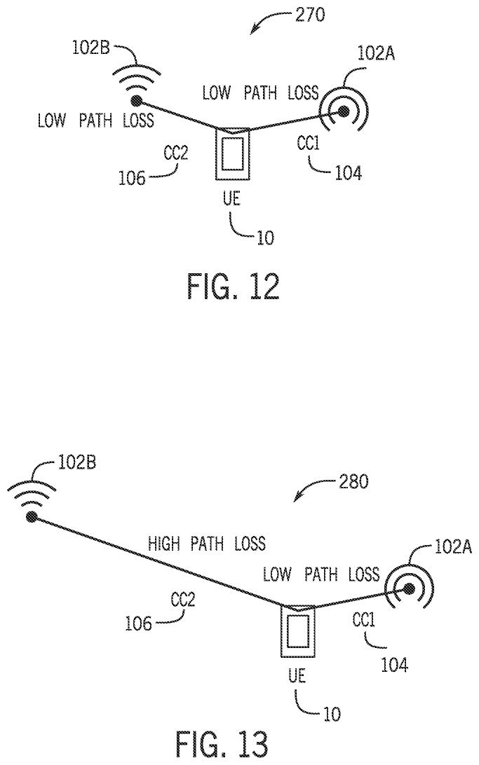

However, in some circumstances, such as when transmission power is low or receive signal strength is high, self-interference may not occur or have little to no impact to a receive signal. FIG. 12 is a communication system 270 where there is low path loss (e.g., little to negligible signal power loss, little to negligible signal quality loss, little to negligible data loss) between the UE 10 and a first base station 102A and low path loss between the UE 10 and a second base station 102B, according to embodiments of the present disclosure. For example, the UE 10 may transmit signals over a first component carrier (CC1) 104 to the first base station 102A, and receive signals over a second component carrier (CC2) 106 from the second base station 102B. There may be low path loss between the UE 10 and the first base station 102A because, for example, the UE 10 is close to (e.g., near a center of coverage area of) the first base station 102A. Accordingly, the low path loss may enable the UE 10 to use decreased (e.g., less than a maximum) transmission power when transmitting signals. Additionally, there may be low path loss between the UE 10 and the second base station 102A because, for example, the UE 10 is close to the second base station 102B. Accordingly, the low path loss may the UE 10 may receive signals from the second base station 102B with high signal quality, signal power, and so on. As a result, self-interference may be less likely to occur or not occur at all, even if transmission frequencies of the first component carrier 104 typically cause harmonic or intermodulation interference with receive frequencies of the second component carrier 106.

FIG. 13 is a communication system 280 where there is low path loss between the UE 10 and the first base station 102A and high path loss between the UE 10 and the second base station 102B, according to embodiments of the present disclosure. As with FIG. 12, the UE 10 may transmit signals over the first component carrier (CC1) 104 to the first base station 102A, and receive signals over the second component carrier (CC2) 106 from the second base station 102B. While the low path loss between the UE 10 and the first base station 102A may enable the UE 10 to use decreased transmission power when transmitting signals, the high path loss between the UE 10 and the second base station 102B may result in the UE 10 receiving signals from the second base station 102B with lower signal quality, signal power, and so on. As a result, self-interference may occur, due to the receiver 54 of the UE 10 operating near its reference sensitivity (REFSENS) level, such that there is not much of a buffer between the receiver 54 receiving a signal with sufficient signal quality and power and a signal with insufficient signal quality and power.

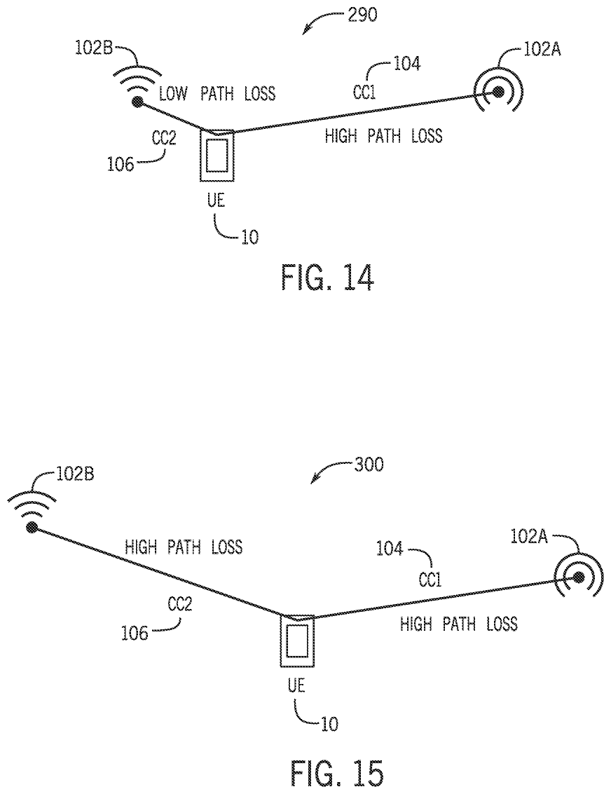

FIG. 14 is a communication system 290 where there is high path loss between the UE 10 and the first base station 102A and low path loss between the UE 10 and the second base station 102B, according to embodiments of the present disclosure. As with FIG. 12, the UE 10 may transmit signals over the first component carrier (CC1) 104 to the first base station 102A, and receive signals over the second component carrier (CC2) 106 from the second base station 102B. While the low path loss between the UE 10 and the second base station 102A may enable the UE 10 to receive signals from the second base station 102B with high signal quality, signal power, and so on, the high path loss between the UE 10 and the first base station 102A may result in the UE 10 transmitting signals to the first base station 102A with higher (e.g., maximum) transmission power. As a result, self-interference may occur, due to the transmitter 52 of the UE 10 boosting power to transmit signals to the first base station 102A, which may cause harmonic or intermodulation interference with receive frequencies of the second component carrier 106.

FIG. 15 is a communication system 300 where there is high path loss between the UE 10 and the first base station 102A and high path loss between the UE 10 and the second base station 102B, according to embodiments of the present disclosure. As with FIG. 12, the UE 10 may transmit signals over the first component carrier (CC1) 104 to the first base station 102A, and receive signals over the second component carrier (CC2) 106 from the second base station 102B. The high path loss between the UE 10 and the first base station 102A may result in the UE 10 transmitting signals to the first base station 102A with higher (e.g., maximum) transmission power, and the high path loss between the UE 10 and the second base station 102B may result in the UE 10 receiving signals from the second base station 102B with lower signal quality, signal power, and so on. As a result, self-interference is more likely to occur, due to both the transmitter 52 of the UE 10 boosting power to transmit signals to the first base station 102A, and the receiver 54 of the UE 10 operating near its reference sensitivity (REFSENS) level, which may result in harmonic or intermodulation interference between signals transmitted over the first component carrier 104 and signals received over the second component carrier 106.

While in some cases, such as the communication system 270 of FIG. 12 where self-interference is unlikely to occur, and the communication system 300 of FIG. 15 where self-interference is more likely to occur, a level of self-interference may be more accurately predicted, at least in other cases, such as the communication system 280 of FIG. 13 and the communication system 290 of FIG. 14, it may be unclear whether there will be self-interference (e.g., a level of self-interference rises to a level to impair communication quality). Accordingly, embodiments disclosed herein may evaluate the level of self-interference, and determine, based on the level of self-interference, whether to operate in a simultaneous RX/TX mode (and increase data throughput) or in a non-simultaneous RX/TX mode (and ensure that self-interference is decreased or at a minimum).

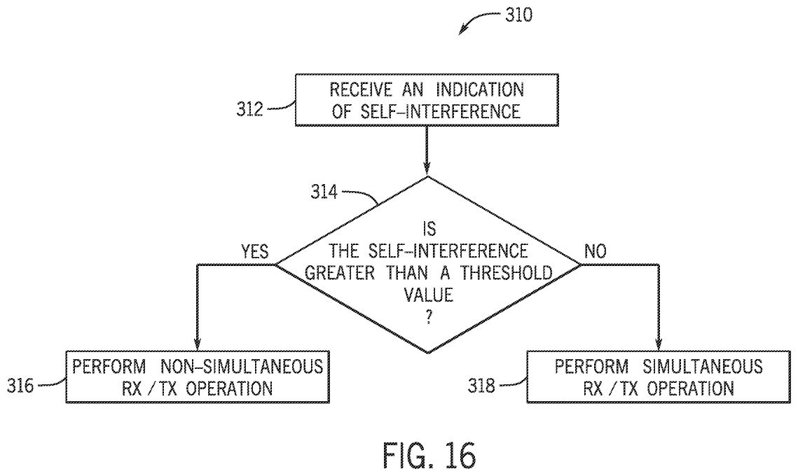

In particular, FIG. 16 is a flowchart of a method 310 for self-interference mitigation at the UE 10 by causing the UE 10 to operate in a non-simultaneous RX/TX mode or a simultaneous RX/TX mode, according to embodiments of the present disclosure. It should be understood that, for the purposes of this disclosure, “mitigate” may mean at least partially mitigate, decrease, decrease a likelihood of, and/or decrease an effect of transmitting signals cause harmonic or intermodulation interference with receiving signals. Any suitable device (e.g., a controller) that may control components of the UE 10 or one or more base stations 102, such as the processor 12, may perform the method 310. In some embodiments, the method 310 may be implemented by executing instructions stored in a tangible, non-transitory, computer-readable medium, such as the memory 14 or storage 16, using the processor 12. For example, the method 310 may be performed at least in part by one or more software components, such as an operating system of the UE 10 or the one or more base stations 102, one or more software applications of the UE 10 or the one or more base stations 102, and the like. While the method 310 is described using steps in a specific sequence, it should be understood that the present disclosure contemplates that the described steps may be performed in different sequences than the sequence illustrated, and certain described steps may be skipped or not performed altogether.

At process block 312, the processor 12 receives an indication of self-interference or receiver sensitivity degradation. In particular, the UE 10 and/or a base station 102 may receive and/or determine whether there is self-interference, or a level of self-interference. In some embodiments, the indication of self-interference (e.g., the level of self-interference) may be determined based on a receive signal quality (e.g., Signal-to-Noise Ratio (SNR), Signal-to-Interference & Noise Ratio (SINR), Reference Signal Received Quality (RSRQ)) at the receiver 54 of the UE 10 in the victim component carrier, a receive signal power (e.g., Reference Signal Received Power (RSRP), Received Signal Strength Indicator (RSSI)) at the receiver 54 in the victim component carrier, and so on. For example, the UE 10 and/or the base station 102 may determine the indication of self-interference based on the receiver 54 from Channel Quality Indicator (CQI) reports, which may be generated by the UE 10 and sent to the base station 102 from the UE 10. In additional or alternative embodiments, the indication of self-interference may be determined based on a transmission power of the transmitter 52 of the UE 10 in the aggressor component carrier. For example, the UE 10 and/or the base station 102 may determine the indication of self-interference based on the transmitter 52 from power headroom reports (PHRs), which may be generated by the UE 10 and sent to the base station 102 from the UE 10. In some cases, the UE 10 and/or the base station 102 may directly determine the indication of self-interference (e.g., in the victim component carrier) by comparing a power of a received signal that includes a desired signal and co-channel interference to a power of the desired signal, which may be received while uplink transmissions (e.g., the transmitter 52) are deactivated. Directly determining the indication of self-interference is explained in further detail in U.S. patent application Ser. No. 17/504,237, filed Oct. 18, 2021, which is herein incorporated by reference in its entirety for all purposes.

At decision block 314, the processor 12 determines whether the self-interference is greater than a threshold value. For example, if the indication of self-interference is related to the receive signal power at the receiver 54, then the threshold value may be that which causes sufficient data throughput loss (e.g., 50% data throughput loss or more, 40% data throughput loss or more, 30% data throughput loss or more, 20% data throughput loss or more, and so on), such as 50 decibels (dB) greater than the receiver's REFSENS level or less, 40 dB greater than the receiver's REFSENS level or less, 30 dB greater than the receiver's REFSENS level or less, and so on. If the indication of self-interference is related to the transmission power at the transmitter 52, then the threshold value may be that which causes sufficient data throughput loss at the receiver 54, such as 30 dB less than the maximum transmission power of the transmitter 52 or more, 20 dB less than the maximum transmission power of the transmitter 52 or more, 10 dB less than the maximum transmission power of the transmitter 52 or more, and so on. In some embodiments, the processor 12 may determine whether the UE's UL resource allocation in the aggressor component carrier and DL resource allocation in the victim component carrier provided by the network 100 correspond to a maximum sensitivity degradation (MSD) scenario occurring, as explained in further detail in incorporated U.S. patent application Ser. No. 17/504,237. In additional or alternative embodiments, the processor 12 may estimate the MSD by calculating a ratio of a victim receive (DL) signal to a transmission power (UL) in the aggressor frequency band, and determine if the ratio is greater than a threshold ratio. The amount by which the ratio exceeds the threshold ratio (which may be programmable) may be used as an estimate of the MSD conditions currently experienced by the UE 10. In cases where the self-interference is directly determined, the processor 12 may determine a Signal-to-Interference Ratio (SIR), and determine if the SIR is greater than a threshold SIR. It should be understood that any of the self-interference criteria discussed above may be combined to determine the indication of self-interference. Indeed, in some embodiments, multiple of the self-interference criteria discussed above may be given a weight, and the indication of self-interference may be determined by applying the weights to the self-interference criteria.

If the processor 12 determines that the self-interference is greater than the threshold value, then the processor 12, at process block 316, performs (e.g., causes the UE 10 to perform) a non-simultaneous RX/TX operation. That is, because there is self-interference (e.g., exceeding a threshold), the UE 10 performs non-simultaneous RX/TX operation to avoid (e.g., decrease a likelihood or effect of) the transmission interfering with reception. If the processor 12 determines that the self-interference is not greater than the threshold value, then the processor 12, at process block 318, performs (e.g., causes the UE 10 to perform) a simultaneous RX/TX operation. That is, because there is a lack of self-interference (e.g., not exceeding the threshold), then the UE 10 performs simultaneous RX/TX operation, as transmission is unlikely to interfere with reception. In this manner, the method 310 may mitigate (e.g., decrease) self-interference at the UE 10 by causing the UE 10 to operate in a non-simultaneous RX/TX mode or a simultaneous RX/TX mode.

In some cases, determining when the UE 10 should operate in a non-simultaneous RX/TX mode or a simultaneous RX/TX mode may be dynamic. For example, the UE 10 may periodically or occasionally send the indication of self-interference to one or more base stations 102 associated with the component carriers 104, 106 (e.g., each component carrier 104, 106 may be used to communicatively couple the UE 10 to a different base station 102A, 102B, or both component carriers 104, 106 may be used to communicatively couple the UE 10 to the same base station 102), such as when requesting to uplink data. For example, the UE 10 may send the indication of self-interference over a Physical Uplink Control Channel (PUCCH), such as when requesting to uplink data. The one or more base stations 102 may then configure the UE 10 for non-simultaneous or simultaneous RX/TX operation based on the indication.

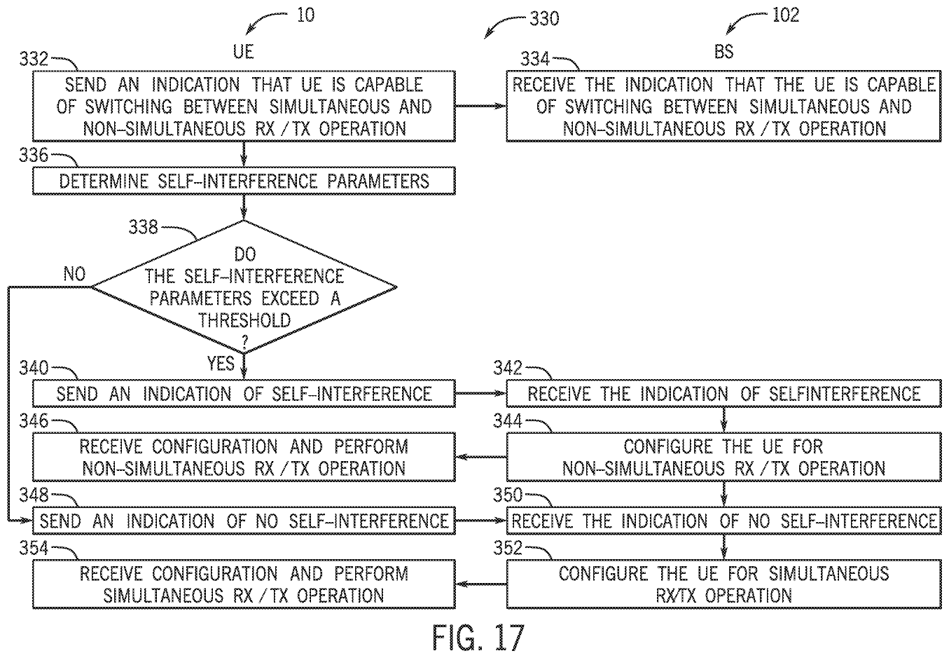

FIG. 17 is a flowchart of a method 330 for self-interference mitigation at the UE 10 by dynamically causing the UE 10 to operate in a non-simultaneous RX/TX mode or a simultaneous RX/TX mode, according to embodiments of the present disclosure. Any suitable device (e.g., a controller) that may control components of the UE 10 or one or more base stations 102, such as the processor 12, may perform the method 330. In some embodiments, the method 330 may be implemented by executing instructions stored in a tangible, non-transitory, computer-readable medium, such as the memory 14 or storage 16, using the processor 12. For example, the method 330 may be performed at least in part by one or more software components, such as an operating system of the UE 10 or the one or more base stations 102, one or more software applications of the UE 10 or the one or more base stations 102, and the like. While the method 330 is described using steps in a specific sequence, it should be understood that the present disclosure contemplates that the described steps may be performed in different sequences than the sequence illustrated, and certain described steps may be skipped or not performed altogether.

At process block 332, the UE 10 sends an indication that UE 10 is capable of switching between simultaneous and non-simultaneous RX/TX operation. If this indication is not received by the base station 102, then the method 330 exits, as the UE 10 cannot switch between simultaneous and non-simultaneous RX/TX operation. At process block 334, the base station 102 receives the indication. At process block 336, the UE 10 determines self-interference parameters. The parameters may include any that indicate that the UE 10 transmitting signals over certain frequencies can cause harmonic or intermodulation interference with received signals over other frequencies, such as those discussed above with respect to process block 312 of FIG. 16.

At decision block 338, the UE 10 determines whether the self-interference parameters exceed a threshold, as discussed above with respect to decision block 314 of FIG. 16. If the UE 10 determines that the self-interference parameters exceed the threshold, then, at process block 340, the UE 10 sends an indication of self-interference to the base station 102. In particular, the UE 10 may set a bit to a first value (e.g., to a high value, such as 1) to indicate self-interference (e.g., the self-interference parameters exceeding the threshold. In some embodiments, the UE 10 may instead send at least some of the self-interference parameters to the base station 102, and the base station 102 may determine whether the self-interference parameters exceed the threshold.

At process block 342, the base station 102 receives the indication of self-interference from the UE 10. At process block 344, the base station 102 configures the UE 10 for non-simultaneous RX/TX operation. That is, because there is self-interference (e.g., exceeding a threshold), the base station 102 configures the UE 10 to perform non-simultaneous RX/TX operation to avoid (e.g., decrease a likelihood or effect of) transmission interfering with reception. At process block 346, the UE 10 receives the configuration and perform non-simultaneous RX/TX operation.

If, at decision block 338, the processor 12 determines that the self-interference parameters do not exceed the threshold, then, at process block 348, the UE 10 sends an indication of no self-interference to the base station 102. In particular, the UE 10 may set a bit to a second value (e.g., to a low value, such as 0) to indicate a lack of self-interference (e.g., the self-interference parameters not exceeding the threshold). At process block 350, the base station 102 receives the indication of no self-interference from the UE 10. At process block 352, the base station 102 configures the UE 10 for simultaneous RX/TX operation. That is, because there is no self-interference (e.g., not exceeding a threshold), the base station 102 configures the UE 10, as transmission is unlikely to interfere with reception. At process block 354, the UE 10 receives the configuration and perform simultaneous RX/TX operation. In this manner, the method 330 may mitigate (e.g., decrease) self-interference at the UE 10 by dynamically causing the UE 10 to operate in a non-simultaneous RX/TX mode or a simultaneous RX/TX mode.

In additional or alternative embodiments, determining when the UE 10 should operate in a non-simultaneous RX/TX mode or a simultaneous RX/TX mode may be event-driven, or driven by the base station 102. Any suitable event is contemplated that is indicative of self-interference at the UE 10. For example, if the UE 10 is on an edge of (e.g., leaving or entering) a coverage area of one or more base stations 102, the one or more base stations 102 may receive or determine self-interference at the UE 10, and then configure the UE 10 for non-simultaneous or simultaneous RX/TX operation based on the self-interference at the UE. Indications of the UE 10 being on an edge of a coverage area may include, for example, a Qₒᵤₜ threshold (which is defined in the 3GPP specification as the level at which a downlink radio link cannot be reliably received) and a Qᵢₙ threshold (which is defined in the 3GPP specification as the level at which the downlink radio link quality can be significantly more reliably received than at Qₒᵤₜ). In some embodiments, the UE 10 may report a capability of its preferred simultaneous/non-simultaneous RX/TX switching point based on, for example, various design parameters specific to the UE's design (e.g., power functions, power efficiency metrics, and so on). Additionally or alternatively, the network 100 may indicate the events that cause switching the UE 10 to non-simultaneous RX/TX mode or simultaneous RX/TX mode in broadcast information, such as in a system information block (SIB). Moreover, the network 100 may configure the event as a base station configuration parameter.

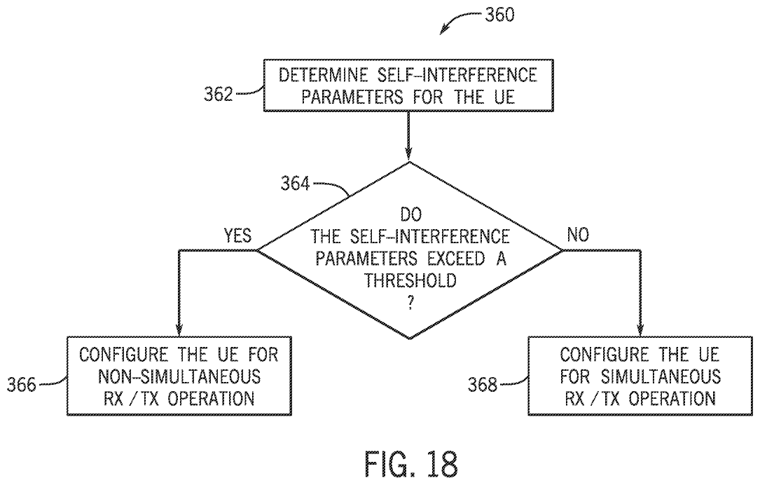

FIG. 18 is a flowchart of a method 360 for self-interference mitigation at the UE 10 by causing the UE 10 to operate in a non-simultaneous RX/TX mode or a simultaneous RX/TX mode as driven by the base station 102, according to embodiments of the present disclosure. Any suitable device (e.g., a controller) that may control components of the UE 10 or one or more base stations 102, such as the processor 12, may perform the method 330. In some embodiments, the method 330 may be implemented by executing instructions stored in a tangible, non-transitory, computer-readable medium, such as the memory 14 or storage 16, using the processor 12. For example, the method 330 may be performed at least in part by one or more software components, such as an operating system of the UE 10 or the one or more base stations 102, one or more software applications of the UE 10 or the one or more base stations 102, and the like. While the method 330 is described using steps in a specific sequence, it should be understood that the present disclosure contemplates that the described steps may be performed in different sequences than the sequence illustrated, and certain described steps may be skipped or not performed altogether.

At process block 362, the processor 12 determines self-interference parameters for the UE 10. The parameters may include any that indicate that the UE 10 transmitting signals over certain frequencies can cause harmonic or intermodulation interference with received signals over other frequencies, such as those discussed above with respect to process block 312 of FIG. 16. Moreover, the base station 102 may configure the UE 10 to send the parameters to the base station 102. For example, the base station 102 may configure the UE 10 to send the PHR to determine the UE's configured output power, and/or configure the UE 10 to send the CQI report and/or use Hybrid Automatic Repeat Request (HARQ) acknowledgement (ACK)/negative acknowledgement (NACK) statistics to determine signal strength received by the UE 10. In some embodiments, the base station 102 may estimate the MSD experienced by the UE 10 by calculating a ratio of a victim receive (DL) signal to a transmission power (UL) in the aggressor frequency band, and determine if the ratio is greater than a threshold ratio. The amount by which the ratio exceeds the threshold ratio (which may be programmable) may be used as an estimate of the MSD conditions currently experienced by the UE 10. As mentioned above, the self-interference parameters may include an event, such as the UE 10 leaving or entering a coverage area of the base station 102. For example, the self-interference parameters may thus include a Qₒᵤₜ threshold and/or a Qᵢₙ threshold.

At decision block 364, the base station 102 determines whether the self-interference parameters exceed a threshold, as discussed above with respect to decision block 314 of FIG. 16. For example, in the case of the self-interference parameters including an event, such as the UE 10 leaving or entering a coverage area of the base station 102, the processor 12 may determine whether the Qₒᵤₜ threshold and/or the Qᵢₙ threshold exceed the threshold values. If the base station 102 determines that the self-interference parameters exceed the threshold, at process block 366, the base station 102 configures the UE 10 for non-simultaneous RX/TX operation. That is, because there is self-interference (e.g., exceeding a threshold), the base station 102 configures the UE 10 to perform non-simultaneous RX/TX operation to avoid (e.g., decrease a likelihood or effect of) transmission interfering with reception. If not, at process block 368, the base station 102 configures the UE 10 for simultaneous RX/TX operation. That is, because there is no self-interference (e.g., not exceeding a threshold), the base station 102 configures the UE 10, as transmission is unlikely to interfere with reception. In this manner, the method 360 may mitigate (e.g., decrease) self-interference at the UE 10 by causing the UE 10 to operate in a non-simultaneous RX/TX mode or a simultaneous RX/TX mode as driven by a base station 102.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment, comprising:
a receiver;
a transmitter; and
processing circuitry communicatively coupled to the receiver and the transmitter, the processing circuitry configured to
determine a level of interference to the receiver caused by the transmitter;
cause the transmitter to send first user data and the receiver to receive second user data concurrently based on the level of interference not exceeding a threshold; and
cause the transmitter to send the first user data and the receiver to receive the second user data at non-overlapping times based on the level of interference not exceeding the threshold.

2. The user equipment of claim 1, wherein the processing circuitry is configured to cause the transmitter to send the first user data and the receiver to receive the second user data concurrently by causing the transmitter to send the first user data on a first component carrier while causing the receiver to receive the second user data on a second component carrier.

3. The user equipment of claim 1, wherein the processing circuitry is configured to cause the transmitter to send the first user data and the receiver to receive the second user data concurrently by causing the transmitter to send the first user data on a first component carrier and third user data on a second component carrier while causing the receiver to receive the second user data on the first component carrier and receive fourth user data on the second component carrier.

4. The user equipment of claim 1, wherein the processing circuitry is configured to cause the transmitter to send the first user data and the receiver to receive the second user data concurrently using carrier aggregation.

5. The user equipment of claim 1, wherein the processing circuitry is configured to cause the transmitter to send the first user data and the receiver to receive the second user data at the non-overlapping times using carrier aggregation.

6. The user equipment of claim 1, wherein the processing circuitry is configured cause the transmitter to send the first user data and the receiver to receive the second user data using frequency division duplexing.

7. The user equipment of claim 1, wherein the processing circuitry is configured to cause the transmitter to send the first user data and the receiver to receive the second user data using time division duplexing.

8. One or more tangible, non-transitory, machine-readable media, storing machine-readable instructions configured to cause processing circuitry to:
transmit an indication that user equipment is capable of switching between a simultaneous receive-transmit operation and a non-simultaneous receive-transmit operation;
transmit an indication of receiver sensitivity degradation to a base station;
receive a configuration to perform the simultaneous receive-transmit operation or the non-simultaneous receive-transmit operation based on the indication of receiver sensitivity degradation; and
perform the simultaneous receive-transmit operation or the non-simultaneous receive-transmit operation.

9. The one or more tangible, non-transitory, machine-readable media of claim 8, wherein the machine-readable instructions configured to cause processing circuitry to transmit the indication that the user equipment is capable of switching between the simultaneous receive-transmit operation and the non-simultaneous receive-transmit operation based on a request to uplink data.

10. The one or more tangible, non-transitory, machine-readable media of claim 8, wherein the machine-readable instructions configured to cause processing circuitry to determine the indication of the receiver sensitivity degradation based on comparing the receiver sensitivity degradation to a threshold.

11. The one or more tangible, non-transitory, machine-readable media of claim 8, wherein the simultaneous receive-transmit operation and the non-simultaneous receive-transmit operation are associated with a plurality of component carriers.

12. The one or more tangible, non-transitory, machine-readable media of claim 8, wherein the indication of receiver sensitivity degradation is associated with a receive signal power or a receive signal quality at a receiver of the user equipment.

13. The one or more tangible, non-transitory, machine-readable media of claim 8, wherein the indication of receiver sensitivity degradation is associated with a transmission power at a transmitter of the user equipment.

14. A method, comprising:
determining, at a base station, self-interference of a transmitter and a receiver of user equipment;
determining, using processing circuitry of the base station, whether the self-interference exceeds a threshold;
configuring, from the base station, the user equipment for non-simultaneous receive-transmit operation based on the self-interference exceeding the threshold; and
configuring, from the base station, the user equipment for simultaneous receive-transmit operation based on the self-interference not exceeding the threshold.

15. The method of claim 14, wherein determining, at the base station, the self-interference of the transmitter and the receiver of the user equipment comprises determining, at the base station, a receive signal power or a receive signal quality at the receiver of the user equipment.

16. The method of claim 15, comprising configuring, from the base station, the user equipment to transmit a channel quality information report and receiving, at the base station, the channel quality information report, wherein determining, at the base station, the receive signal power or the receiver signal quality at the receiver of the user equipment is based on the channel quality information report.

17. The method of claim 15, comprising receiving, at the base station, Hybrid Automatic Repeat Request (HARQ) acknowledgement (ACK)/negative acknowledgement (NACK) statistics, wherein determining, at the base station, the receive signal power or the receiver signal quality at the receiver of the user equipment is based on the HARQ ACK/NACK statistics.

18. The method of claim 14, wherein determining, at the base station, the self-interference of the transmitter and the receiver of the user equipment comprises determining, at the base station, a transmission power at the transmitter of the user equipment.

19. The method of claim 18, comprising configuring, from the base station, the user equipment to transmit a power headroom report and receiving the power headroom report, wherein determining, at the base station, the transmission power at the transmitter of the user equipment is based on the power headroom report.

20. The method of claim 14, wherein determining, at the base station, the self-interference of the transmitter and the receiver of the user equipment comprises receiving and determining, at the user equipment, a power of a signal including a desired signal and co-channel interference, deactivating, at the user equipment, the transmitter, receiving and determining, at the user equipment, a power of the desired signal, and comparing, at the user equipment, the power of the signal to the power of the desired signal.
